(19) United States
(12) Patent Application Publication
(10) Pub. No.: US 2008/0041163 A1
(43) Pub. Date: Feb. 21, 2008

(54) Particle Detection

(76) Inventors: Bahman Tohidi, Midlothian (GB); Jinhai Yang, Edinburgh (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/579,780

(22) PCT Filed: May 12, 2005
(86) PCT No.: PCT/GB05/01876

§ 371 Date: Jul. 16, 2007

(30) Foreign Application Priority Data
May 12, 2004 (GB) 0410533.4

(51) Int. Cl. G01H 3/06

(52) U.S. Cl. 73/659

(57) ABSTRACT

A method for detecting particles in a fluid involves passing any ultrasonic signal through the fluid. A Fast Fourier Transform analysis is performed on the received signal, to determine a characteristic frequency of the fluid where the amplitude is greatest. Both the amplitude of FFT spectrum at the characteristic frequency and the time-domain amplitude are monitored. A drop either in the amplitude of the FFT spectrum at the characteristic frequency or the time-domain amplitude indicates the appearance of particles in the fluid.

### FIELD OF THE INVENTION

The present invention relates to the detection of particles in a fluid. It has particular applicability to the fields of petroleum and production engineering, flow assurance, in detecting hydrate, wax, asphaltene and salt formation, as well as other fields, for example, liquid condensation, or detecting suspended materials in the air for the monitoring of air quality.

### BACKGROUND TO THE INVENTION

Solid deposition within a fluid (in the form of gas hydrates, wax, asphaltene, salt) has caused a lot of concern in the oil industry. It is a cause behind the plugging (or reduction in the capacity) of production and transportation pipelines. These situations result in huge economic loss for the oil industry. The industry addresses these problems by various preventative methods; for example, by using thermodynamic inhibitors and kinetic inhibitors to prevent or at least delay the onset of gas hydrate formation.

Thermodynamic inhibitors are compounds that form relatively strong bonds with water molecules, reducing the ability of water to form gas hydrates. This shifts the hydrate stability zone to higher pressure and lower temperature conditions. Methanol, ethylene glycol and ethanol are some of the most common thermodynamic inhibitors. Salts, which are generally present in produced water, are also thermodynamic inhibitors against hydrate formation.

In practical applications the quantity of a thermodynamic inhibitor necessary to introduce the required hydrate stability conditions can be quite large, for example, more than 30 percent by mass of the aqueous phase. This can cause high costs and increase environmental concerns. Because of this, kinetic inhibitors are increasingly being used to avoid problems. Consequently, greater importance is being attached to understanding the technical features of kinetic inhibitors.

Kinetic hydrate inhibitors are a type of chemical additive that can be used to prolong the induction time and delay the catastrophic growth of hydrates. Induction time is defined as the elapsed time of a fluid in the hydrate stability zone until hydrate formation, denoted by the appearance of measurable hydrate crystals. The hydrate stability zone is the range of pressure and temperature conditions in which hydrates could form and is a function of the system composition.

The behaviour of a system with kinetic hydrate inhibitors present is usually studied by making temperature and pressure measurements. FIG. 1 shows a typical hydrate phase boundary plotted on a temperature/pressure graph to show the hydrate stability zone. FIG. 2 shows pressure and temperature plotted against time for a typical natural gas-water system. The composition of the natural gas is shown in Table 1 below.

TABLE 1
Composition of the natural gas

| Component | Mol % | Component | Mol % |
|---|---|---|---|
| N₂ | 3.86 | i-C₄ | 0.2 |
| CO₂ | 1.5 | n-C₄ | 0.35 |
| C₁ | 86.49 | i-C₅ | 0.08 |
| C₂ | 5.71 | n-C₅ | 0.08 |
| C₃ | 1.63 | C₆₊ | 0.1 |

As shown in FIG. 2, the system pressure stabilises at around 1450 psia when the system temperature is around 4° C. Under these conditions, this system is inside the hydrate stability zone. At these temperature and pressure conditions formation of hydrate is thermodynamically favoured and expected to occur. Both temperature and pressure remain stable until about 1400 minutes from the start of the study. The sudden drop in pressure at 1400 minutes occurs when hydrate crystal growth is rapid and substantial. Studies such as these are useful for measuring induction time. In this case gas hydrates did not form until about 1200 (1400-200) minutes after the system was inside the hydrate stability zone and so the induction time is 1200 minutes. A disadvantage of this method is that pressure measurements are not sufficiently sensitive to detect the early beginning of hydrate formation i.e. nucleation of hydrates.

One known method for identifying gas hydrate nucleation is the visual observation of turbidity in the liquid phase as discussed in “Natarajan V., Bishnoi P. R. and Kalogerakis N., 1994. Induction phenomena in gas hydrate nucleation, Chemical Engineering Science, 49, 2075-2087”. However, this method is not sensitive enough to identify the very beginning of hydrate nucleation. This is because it is based on visual observation, so only the formation of visible gas hydrate crystals, rather than the onset of nucleation can be determined by turbidity observation.

Another method for identifying gas hydrate nucleation is laser light scattering, as discussed in “Nerheim A. R. and Svartaas T. M., 1992. Investigation of hydrate kinetics in the nucleation and early growth phase by laser light scattering, Proceedings of the Second International Offshore and Polar Engineering Conference, San Francisco, USA, 14-19 Jun. 1992”. Although laser scattering can be used to detect hydrate nucleation and determine the size distribution of hydrate nuclei, the focused laser beam can only determine the nucleation that is happening at one point, and is at risk of missing nucleation happening away from the point of focus. It is impossible for the laser scattering method to follow very rapid nucleation. At the beginning of nucleation, the scattering signal can be very weak. Consequently a long time may be required to sample sufficient signal to obtain a meaningful result. Finally, the laser scattering method may cause sample heating, at the point of examination. This is because of the highly concentrated light energy from the laser, especially when higher powers are used to gain high sensitivity. This can influence the nucleation process and so compromise the quality of the measurements.

Sonic velocity measurements utilising ultrasound have been used to determine salt nucleation in pure borax solutions, as discussed in “H. Guburz, B Ozdemir, Experimental determination of the metastable zone width of borax decahydrate by ultrasonic velocity measurement; Journal of crystal growth 252 p 343-349 2003”. However, it has been found on testing that there was no measurable velocity change in aqueous solution during hydrate nucleation. This limits sonic velocity measurements to particular spheres of application.

The ability to identify hydrate formation and monitor it as a function of time is essential to understanding the inhibition mechanism of kinetic hydrate inhibitors. Equally the ability to identify other types of particle formation would provide a means for investigating various phenomena such as condensation, evaporation, salt precipitation, wax and/or asphaltene formation and crystallization in solutions.

It is an object of the present invention to avoid or minimise at least some of the foregoing limitations.

### SUMMARY OF THE INVENTION

According to a first aspect the present invention provides a method for detecting particles in a fluid comprising: passing an ultrasonic signal through a fluid; receiving a signal that has passed through the fluid; performing a Fast Fourier Transform (FFT) analysis on the received signal to obtain a FFT spectrum; determining a characteristic frequency of the fluid, where the amplitude of the FFT spectrum is greatest; and monitoring the amplitude of the FFT spectrum at the characteristic frequency.

The present invention provides a method for the detection of nucleation of particle growth in a fluid comprising: passing an ultrasonic signal through a fluid; receiving a signal that has passed through the fluid; performing a Fast Fourier Transform (FFT) analysis on the received signal to obtain a FFT spectrum; determining a characteristic frequency of the fluid, where the amplitude of the FFT spectrum is greatest; and monitoring the amplitude of the FFT spectrum at the characteristic frequency.

The method may further comprise monitoring the amplitude of the signal passed through the fluid before Fast Fourier Transform analysis.

The signal may be monitored and analysed in transmission mode i.e. the signal is monitored after passing directly through the fluid or a portion of the fluid.

Preferably, the ultrasound signal used is emitted in a pulsed mode.

It will be understood that the term ‘ultrasound’ refers to sound waves with a frequency above 20 kHz i.e. above human hearing. Typically the frequency transmitted into a fluid when using the method of the invention is about 1 MHz, however, other frequencies can be used.

Knowing the change in the amplitude values of characteristic frequencies determined by FFT analysis in a fluid due to scattering and absorption, the appearance of particles can be determined, for example the onset of nucleation in gas hydrate formation. Monitoring changes in the amplitude of the signal received in time domain, after passing through a portion of fluid, can also be used but is generally found to be less sensitive. It has been found that the amplitude of the characteristic frequency falls at the onset of nucleation and that the amplitude of the received signal as a whole tends to drop noticeably only where substantive particle growth is established. A combination of monitoring both the amplitude of FFT spectrum at the characteristic frequency, i.e., in frequency domain, and the signal amplitude in time domain has been found effective in detecting and studying gas hydrate nucleation.

The period of nucleation, the time during which nucleation rather than substantive particle growth is occurring can also be determined by the method of the invention. This is because a second, substantial drop in the amplitude of the FFT spectrum at the characteristic frequency has been found to occur when substantive particle growth occurs. Determining the period between the first and second drops in amplitude of the FFT spectrum at the characteristic frequency provides a measure of the nucleation period. The amplitude of the received signal in the time domain also shows a significant drop when substantive particle growth occurs.

In this description it will be understood that the term ‘particles’ means any small portions of material that have different acoustic properties to the bulk fluid being tested. Typically the particles will be of a different phase to the fluid (e.g. liquids in a gas, or gases in a liquid, or solids in a liquid, or solids in a gas), but the method can also be applied to the detection of for example, liquid droplets in a liquid (oil droplets in water), provided that the contrast in acoustic properties between the particles and the fluid is sufficiently large.

The method of the invention is suitable for carrying out measurements in an experimental (laboratory) or field situation.

According to another aspect the present invention provides apparatus for the detection of particles appearing in a fluid, the apparatus comprising: means for passing an ultrasonic signal into a fluid; means for receiving a signal that has passed through the fluid; means for performing a Fast Fourier Transform (FFT) analysis on the received signal to obtain a FFT spectrum and determining a characteristic frequency of the fluid, where the amplitude of the FFT spectrum is greatest; and means for monitoring the amplitude of the FFT spectrum at the characteristic frequency.

The apparatus may further comprise means for monitoring the time-domain amplitude of a signal that has passed through the fluid.

The means for passing an ultrasonic signal through a fluid and receiving the signal after it has passed through the fluid can be, for example, an ultrasonic pulser/receiver and two compressional transducers. The pulser/receiver produces pulse signals that are transmitted by one transducer to pass into the fluid and received by the other transducer, which sends the received signal to the pulser/receiver. The means for carrying out the Fast Fourier Transform Analysis and monitoring of frequency amplitude can be, for example a digital storage oscilloscope and a personal computer. Signals from the receiver of the pulser/receiver are converted from analogue signal to digital signal by the digital storage oscilloscope, displayed and stored by a personal computer, and analysed by appropriate software.

For research work on hydrate nucleation the equipment used typically involves a vessel or sample cell for the fluid being tested, which is fitted with two transducers. One, for transmitting the signal into the fluid and the other, for receiving a signal from the fluid. Preferably the sample cell also has temperature-adjusting means and/or pressure-adjusting means so that temperature and pressure can be changed to examine the behaviour of a given fluid system under a wide range of conditions.

### BRIEF DESCRIPTION OF THE DRAWINGS

Various aspects of the invention will now be described by way of example only and with reference to:

FIGS. 3a and 3b which show the results of experiments where the amplitude in time domain and the amplitude of the FFT spectrum at the characteristic frequency were monitored during hydrate formation; and

FIG. 4 which shows schematically an apparatus of the invention.

### DETAILED DESCRIPTION OF DRAWINGS

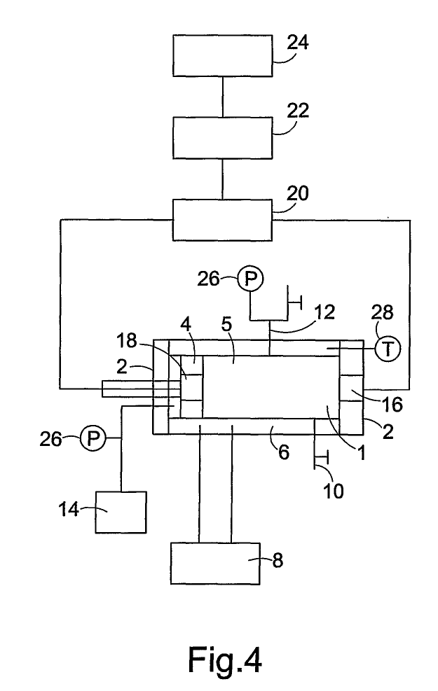

An apparatus suitable for carrying out experimental work to study nucleation of hydrates, waxes, asphaltene, or other crystallisation in general is illustrated in FIG. 4. The apparatus comprises a sample cell 1, which is a cylinder closed at each end 2. In the cell 1 is a piston 4, which allows the sample volume 5 of the cell 1 to be adjusted. The sample cell has a heating/cooling jacket 6 through which coolant is pumped from a cooling bath 8. The sample cell 1 has an inlet 10 and an outlet 12 through which samples of fluid, gas or liquid, can be introduced and the pressure adjusted. Pressure adjustment can also be carried out by movement of the piston 4. This is accomplished by use of a hand pump 14, which introduces hydraulic pressure behind the piston 4. Of course a sample cell not including the piston 4 could be used to carry out the methods of the invention, with pressure control being achieved solely by adjusting the sample pressure via the inlet and outlet 10,12.

Two ultrasonic transducers 16,18 which can act as either transmitters or receivers of ultrasound are fitted opposite each other across the sample volume 5 of the cell, one 16 housed in the end cap of the sample cell distal from the piston, the other housed in the piston end. The transducers are fitted with appropriate couplants to ensure good transmission of ultrasound through samples placed in the cell. A pulser/receiver 20 emits a pulsed signal to stimulate the transmitting transducer, and receives the signal through the transducers 16,18. The outputs received from the receiving transducer by the pulser/receiver 20 are sent to a digital oscilloscope 22, which in turn is connected to a personal computer 24 for storage and analysis of data collected from the ultrasonic transducers and pressure 26 and temperature 28 probes. The temperature probe 28 is located in the wall of the sample cell 1 and the pressure probe 26 in the outlet 12 of the sample cell.

Ultrasound is passed through the fluid that is being studied and received by one of the transducers 16,18. Preferably the ultrasound is emitted in pulses to simplify the analysis of the received signal. Typically a 1 MHz signal is passed through the fluid. However, other frequencies can be used. For a given fluid the frequency that gives best results in terms of sensitivity and transmission would be selected. Generally high frequencies give the most sensitive response, but such frequencies are more easily reflected leading to loss of received signal strength, i.e., higher attenuation.

The received signal is then analysed and monitored. A Fast Fourier Transform analysis of the received signal is carried out to obtain a FFT spectrum. This is used to determine the characteristic frequency of the fluid sample, i.e. the frequency at which the FFT spectrum has the highest amplitude. Monitoring the amplitude of the FFT spectrum at the characteristic frequency is continued as conditions within the sample cell are altered. Simultaneously the time-domain amplitude of the received signal can be monitored. The start of nucleation is indicated by an initial drop in the amplitude of FFT spectrum at the characteristic frequency or both in the amplitude of the FFT spectrum at the characteristic frequency and in the time-domain amplitude of the received signal. Generally at this point the conventional pressure data from a sample does not show a detectable change.

Analysis and monitoring can be represented directly in voltage or in dimensionless units after normalisation. Conveniently, the amplitude data, both in frequency domain and in time domain, are displayed graphically on a display together with temperature and pressure data, enabling the changes in amplitude to be detected visually on the graph. Alternatively, the analysis of the signal can be performed directly on the data from the receiving transducer without graphical representation.

As well as detecting the onset of nucleation, the method also allows determination of the period of nucleation, that is the time during which nucleation, rather than substantive particle (crystal) growth is occurring. This is because a second, substantial drop in amplitudes in frequency domain and time domain has been found to occur when substantial crystal growth begins. A fall in the pressure of the sample cell can also be expected when substantial crystal growth occurs. The time difference between the changes in amplitudes is the period of nucleation.

Experiments were carried out using the system of FIG. 4 to study natural gas-distilled water mixtures with and without added kinetic inhibitors. In a first example, distilled water was prepared for testing, and no inhibitor was added. A vacuum was then applied to the test cell, and the sample introduced into the cell. Next the test gas was introduced to pressurise the system to the desired pressure. The system was left to achieve equilibrium. Then the system was cooled using the cooling jacket and the process of collecting data including the waveforms of the received ultrasonic signal and the temperature and pressure was carried out. Received data was processed and analysed. This analysis included a Fast Fourier Transform, and a comparison of the amplitude of the raw data, as well as sample pressure and temperature data.

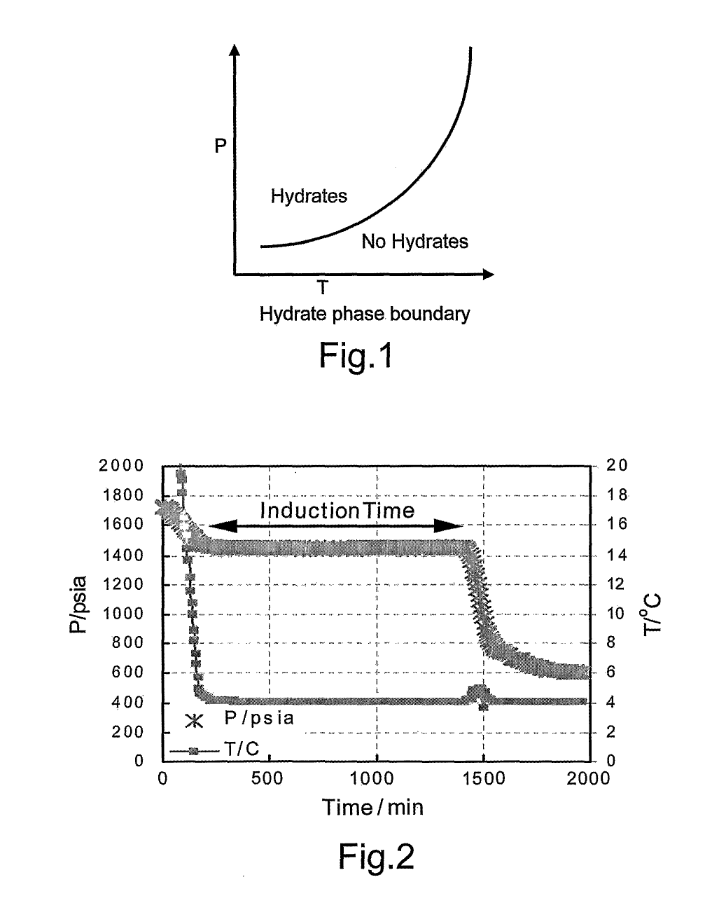

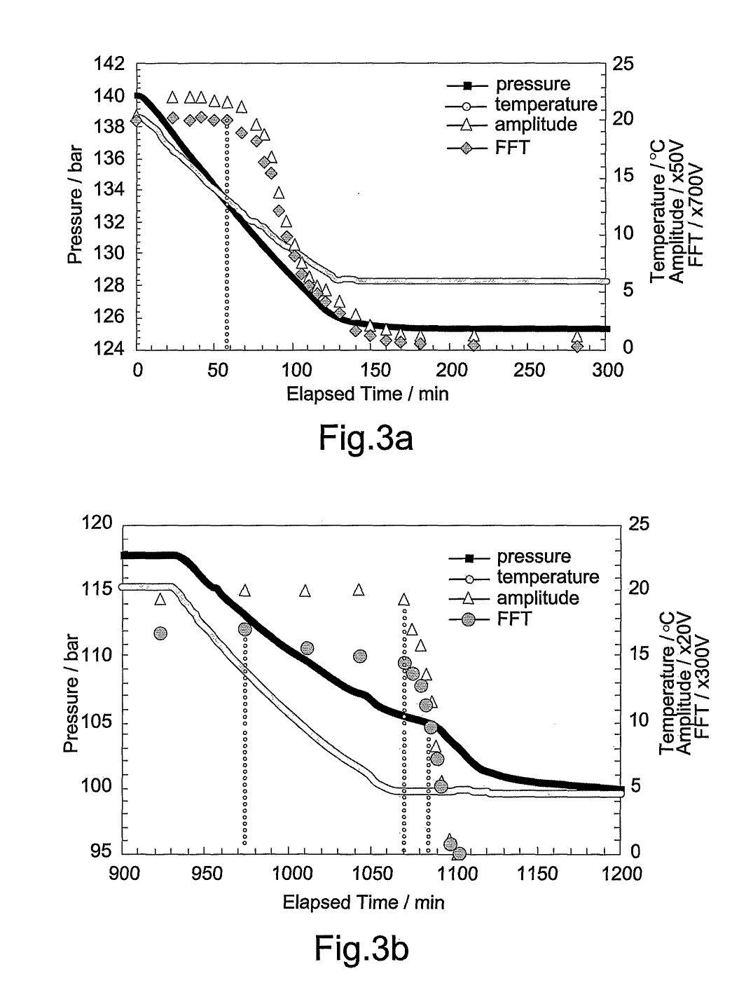

FIG. 3a shows measurements taken on the natural gas-distilled water mixture without added inhibitors. This shows a continuous drop of the frequency-domain amplitude and the time-domain amplitude indicating the beginning of hydrate formation at 133.2 bar and 13.1° C. In contrast, the pressure profile did not respond to hydrate formation at this point due to only minute quantities of hydrates being formed. In this case, without any inhibitor present, there was no detectable time gap between nucleation and substantial formation of hydrate crystals.

FIG. 3b shows results when a kinetic inhibitor was included in the sample. The inhibitor used was PVCap at a concentration of 1 mass %. In this case, the amplitude of the FFT spectrum at the characteristic frequency started continuously declining at 973 min while the time-domain amplitude kept constant and the pressure smoothly decreased as the system was cooled down. This indicates that hydrate nucleation was slowly happening. Furthermore this demonstrates the greater sensitivity of using the amplitude of the FFT spectrum at the characteristic frequency to detect the appearance of particles rather than the time-domain amplitude.

At 1070 minutes, about 15 min before the catastrophic formation of gas hydrates, both the frequency and time-domain amplitudes dropped sharply. This can be attributed to the fact that hydrate nuclei are rapidly growing to their critical sizes where hydrate crystals may be detected by other means such as microscopy. This is the point just before catastrophic growth. Large decreases in amplitude both in frequency domain and in time domain are due to the formation of larger nuclei or crystals and/or the presence of more nucleation sites.

At about 1085 min, the pressure signal shows a substantial drop indicating that catastrophic crystal growth is occurring. Thus it can be seen that the monitoring of the amplitude of the FFT spectrum at the characteristic frequency provides an early indication that hydrate nuclei have been produced in the sample. Furthermore the modification to the behaviour of the gas/water system made by adding the kinetic inhibitor can be studied by comparing results of experiments with and without varying quantities of the selected inhibitor.

Hydrate nucleation tests in natural gas-water, THF-water and CO₂-water systems have been conducted, with successful detection of nucleation, the appearance of particles in all cases.

It should be noted that the acoustic energy used as test signal has been found to have a negligible impact on nucleation. This ensures that the methods of the invention are ideal for such investigations.

The system described with reference to FIG. 4 is a lab-based system. However, as will be appreciated, the method of the invention can also be applied to testing fluids in the field. For example fluids flowing in a pipeline can be monitored for the nucleation of hydrate, wax or asphaltene by the provision of suitable sampling points, which allow extraction of samples of fluid for testing according to the method. The method of the invention can be carried out in a continuous mode by fitting the necessary transducers to a pipeline allowing analysis of the fluid flowing in the pipeline.

The method in which the invention is embodied can provide high sensitivity monitoring for nucleation, which makes it possible to both identify the very beginning of nucleation and monitor the kinetic process of nucleation. It also provides a useful and practical method to determine the time-dependence of nucleation and growth. This is essential to not only understanding the kinetic mechanism of kinetic inhibitors, but also investigation of various phenomena such as condensation, evaporation, salt precipitation, wax and/or asphaltene formation and other crystallizations in solutions or gases. A further advantage is that the invention can be implemented at a low cost compared to known techniques. It is also highly reliable and can be employed in an on-line monitoring process.

The method of the invention is applicable to the appearance of particles or nucleation of crystals in both the gas or liquid phase and can be used, for example, to detect the appearance of bubbles in a fluid, or liquid or solid (e.g. water, hydrate, ice) particles formed in a cooling gas mixture, such as dew point measurement. When used for dew point measurement the temperature at which the formation (nucleation) of liquid droplets is detected has been found to be noticeably higher than the dew point temperature as measured by the conventional mirror misting measurement technique. This demonstrates the high sensitivity of the method.

The method described herein is of particular importance in any industry in which nucleation leading to solid formation or liquid condensation, or the amount of solid and/or liquid droplets in a medium is of importance (such as in the case of monitoring water quality or the concentration of oil droplets in produced or overboard water in petroleum operations). It is also important for any industry using inhibitors to delay nucleation and the growth of solids in liquids or gas. Another application could be in the case of an early warning system against hydrate (or other solid) formation, giving an operator enough time to respond and prevent hydrate blockage by changing the operating conditions and/or injecting inhibitors. In other fields such as chemistry and medicine the method can be used to examine phenomena such as salt precipitation and crystallisation in liquid solution.

The ability to observe the effect of kinetic inhibitors on nucleation time provides a powerful tool for testing kinetic inhibitors and their performance. It can be used for screening proposed inhibitors, as well as synergic additives. The method can also be applied to evaluation and screening of kinetic inhibitors for prevention of the formation of other solids, for example wax, asphaltene, scale or halite.

1. A method for detecting particles in a fluid comprising: passing an ultrasonic signal through a fluid; receiving a signal that has passed through the fluid; performing a Fast Fourier Transform (FFT) analysis on the received signal to obtain a FFT spectrum; determining a characteristic frequency of the fluid, where the amplitude of the FFT spectrum is greatest; and monitoring the amplitude of the FFT spectrum at the characteristic frequency.

2. A method for the detection of nucleation of particle growth in a fluid comprising: passing an ultrasonic signal through a fluid; receiving a signal that has passed through the fluid; performing a Fast Fourier Transform (FFT) analysis on the received signal to obtain a FFT spectrum; determining a characteristic frequency of the fluid, where the amplitude of the FFT spectrum is greatest; and monitoring the amplitude of the FFT spectrum at the characteristic frequency.

3. A method of determining the period of nucleation of particle growth in a fluid comprising: monitoring the amplitude of the FFT spectrum at the characteristic frequency according to claim 2; and determining the period between a first and a second decrease in the amplitude of the FFT spectrum at the characteristic frequency.

4. A method according to claim 1, which includes monitoring the time-domain amplitude of the signal passed through the fluid.

5. A method according to claim 1, wherein the received signal is received from the fluid in transmission mode.

6. A method according to claim 1, wherein the ultrasound signal is a pulsed signal.

7. Apparatus for the detection of particles appearing in a fluid, the apparatus comprising: means for passing an ultrasonic signal into a fluid; means for receiving a signal that has passed through the fluid; means for performing a Fast Fourier Transform (FFT) analysis on the received signal to obtain a FFT spectrum and determining a characteristic frequency of the fluid, where the amplitude of the FFT spectrum is greatest; and means for monitoring the amplitude of the FFT spectrum at the characteristic frequency.

8. Apparatus according to claim 7, which includes means for monitoring the time-domain amplitude of a signal that has passed through the fluid.
